(19) United States
(12) Patent Application Publication
(10) Pub. No.: US 2018/0297692 A1
(43) Pub. Date: Oct. 18, 2018

(54) REDUCED BLADE VORTEX INTERACTION

(71) Applicant: Sikorsky Aircraft Corporation, Stratford, CT (US)

(72) Inventors: Daniel C. Sargent, Stratford, CT (US); Mark W. Scott, Bethany, CT (US)

(21) Appl. No.: 15/768,767

(22) PCT Filed: Oct. 12, 2016
(86) PCT No.: PCT/US16/56514

§ 371 Date: Apr. 16, 2018

Related U.S. Application Data
(60) Provisional application No. 62/243,007, filed on Oct. 17, 2015.

(51) Int. Cl. B64C 21/04; B64C 27/467; B64C 27/82

(52) U.S. Cl. CPC B64C 21/04; B64C 2230/20; B64C 27/82; B64C 27/467

(57) ABSTRACT

A blade includes an elongated body having a leading edge, a trailing edge, a root end, and a tip end, a fluid inlet arranged closer to the root end than the fluid outlet, a fluid outlet arranged near the tip end of the elongated body, and a centrifugal air flow channel defined within the body between the inlet and the outlet to direct air from the inlet to the outlet to issue the flow when the rotor blade is rotating in a rotational path. The blade also includes a valve to selectively open and close the centrifugal air flow channel to selectively issue the flow and change a blade vortex issuing from the rotor blade at discrete portions of the rotational path of the rotor blade. A controller can be operatively connected to the valve to control the valve to open and close the centrifugal air flow channel.

### CROSS REFERENCE TO RELATED APPLICATIONS

The subject invention claims the benefit of and priority to U.S. Provisional Application Ser. No. 62/243,007 filed Oct. 17, 2015, the disclosure of which is herein incorporated by reference in its entirety.

### BACKGROUND

### 1. Field

The present disclosure relates to blade noise reduction, more specifically to the reduction of rotor blade vortex interaction noise and vibrations typical of rotorcraft (or other propeller aircraft).

### 2. Description of Related Art

Blade vortex interaction (BVI) noise occurs when an aircraft rotor or propeller blade interacts with a preceding blade's shed and/or tip vortex. Under certain flight conditions (e.g. low speed descent) the rapid change in blade aerodynamic loading associated with this interaction results in a loud and impulsive acoustic event that can increase levels of community annoyance and increase the aircrafts aural detectability. In both civil and military operations, it is desirable to reduce BVI related noise. This interaction can also result in increased vibratory loads.

Many passive and active devices have been proposed to reduce the strength of BVI by manipulating the interactional geometry or altering the strength of the interaction. Such methods and systems have generally been considered satisfactory for their intended purpose under controlled situations but are often too complex or unreliable to warrant regular use. There is still a need in the art for improved low BVI noise rotor designs with low system complexity and high reliability. The present disclosure provides a solution for this need.

### SUMMARY

In accordance with at least one aspect of this disclosure, a blade includes an elongated body having a leading edge, a trailing edge, a root end, and a tip end, a fluid inlet arranged closer to the root end than the fluid outlet, a fluid outlet arranged near the tip end of the elongated body, and a centrifugal air flow channel defined within the body between the inlet and the outlet to direct air from the inlet to the outlet to issue the flow when the rotor blade is rotating in a rotational path. The blade also includes a valve to selectively open and close the centrifugal air flow channel to selectively issue the flow and change a blade vortex issuing from the rotor blade at discrete portions of the rotational path of the rotor blade. A controller can be operatively connected to the valve to control the valve to open and close the centrifugal air flow channel.

The outlet can be positioned at or near the distal end of the body to inject flow into the vortex formed and released at the tip end of the rotor blade so as to disrupt the formation, strength and/or displacement of the vortex at or near its point of origin. The outlet can be configured to issue flow perpendicular to the direction of flow around the tip end of the elongated body. However, any other suitable angle relative to the flow to affect the vortex as desired is contemplated herein.

The inlet can be positioned and configured to cause air flow through the air flow channel due to rotation of the rotor blade. In certain embodiments, the inlet can be positioned at or near a root end of the elongated body and can be aligned along any edge or surface of the body (e.g. trailing edge, leading edge, proximal edge, upper surface or lower surface).

The blade can be a helicopter main rotor blade or any other suitable rotating, lift generating body exposed to vortex interaction (e.g. a tiltrotor proprotor blade, a helicopter tail rotor blade, a pusher/tractor propeller blade).

In accordance with at least one aspect of this disclosure, a method of controlling a blade vortex issuing from a rotating rotor blade includes injecting a centrifugal air flow into the blade vortex formed on a rotor blade tip to disrupt the blade vortex at a first location in a rotational path of the rotor blade such that the disrupted blade vortex does not interact with another object, and interrupting the injection of the centrifugal air flow to no longer disrupt the blade vortex at a second location in a rotational path of the rotor blade. The method can include allowing the centrifugal air flow through a centrifugal air flow channel defined in a rotorcraft blade and through an outlet defined in the blade tip of the blade to disrupt the vortex. The method can include actuating a valve disposed within the centrifugal air flow channel to selectively control the centrifugal air flow through the rotorcraft blade at a specific blade positions.

Injecting air flow into the vortex can include injecting air flow at predetermined rotor blade positions to control how the tip vortex interacts with at least one of a main rotor blade, a tail rotor blade, or a proprotor blade. For example, the positions can be chosen so as to modify the interaction with an oncoming blade of the same rotor or so as to modify the interaction with a blade of a separate rotor (e.g. main rotor/tail rotor interaction).

In accordance with at least one aspect of this disclosure a rotorcraft includes a rotorcraft blade similar to the blade as described above. The blade vortex is changed to avoid interacting with another object on the rotorcraft. The valve can open to change the blade vortex when each of the rotor blades is on an advancing side of the rotational path to prevent interacting with another of the rotor blades on the advancing side of the rotational path, and can close when on the retreating side of rotational path.

The rotorcraft can include a second rotor system rotationally disposed on the fuselage, wherein a second valve can open to change the blade vortex when each of the rotor blade is on an advancing side of the rotational path to prevent interacting with the second rotor system, and the second valve can close when on the retreating side of rotational path. A controller can be disposed in the fuselage which controls each of the valves in the rotor blades to selectively open and close the centrifugal air flow channel at the discrete portions of the rotational path of the rotor blade.

These and other features of the systems and methods of the subject disclosure will become more readily apparent to those skilled, in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1A is a cross-sectional schematic plan view of an embodiment of a rotor blade in accordance with this disclosure, showing the inlet defined in the trailing edge of the blade;

FIG. 1B is a cross-sectional schematic plan view of an embodiment of a rotor blade in accordance with this disclosure, showing the inlet defined in the leading edge of the blade;

FIG. 1C is a cross-sectional schematic plan view of an embodiment of a rotor blade in accordance with this disclosure, showing the inlet defined in the root end of the blade;

FIG. 1D is a cross-sectional schematic plan view of an embodiment of a rotor blade in accordance with this disclosure, showing the inlet defined in through a partial thickness of the blade in a root portion;

FIG. 2 is a cross-sectional schematic plan view of another embodiment of a rotor blade in accordance with this disclosure showing a valve disposed therein;

FIG. 3 is schematic plan view of a rotorcraft utilizing the embodiment of the rotor blade of FIG. 1, shown issuing centrifugal air flow from a tip thereof due to rotational motion of the blade to reduce main rotor blade vortex interaction;

FIG. 4 is schematic plan view of a rotorcraft utilizing the embodiment of rotor blade of FIG. 1, shown issuing centrifugal air flow from a tip thereof due to rotational motion of the blade to reduce tail rotor blade vortex interaction; and

FIG. 5 is schematic plan view of a rotorcraft utilizing the embodiment of the rotor blade of FIG. 1, shown issuing centrifugal air flow from a tip thereof due to rotational motion of the blade to reduce pusher prop blade vortex interaction.

### DETAILED DESCRIPTION

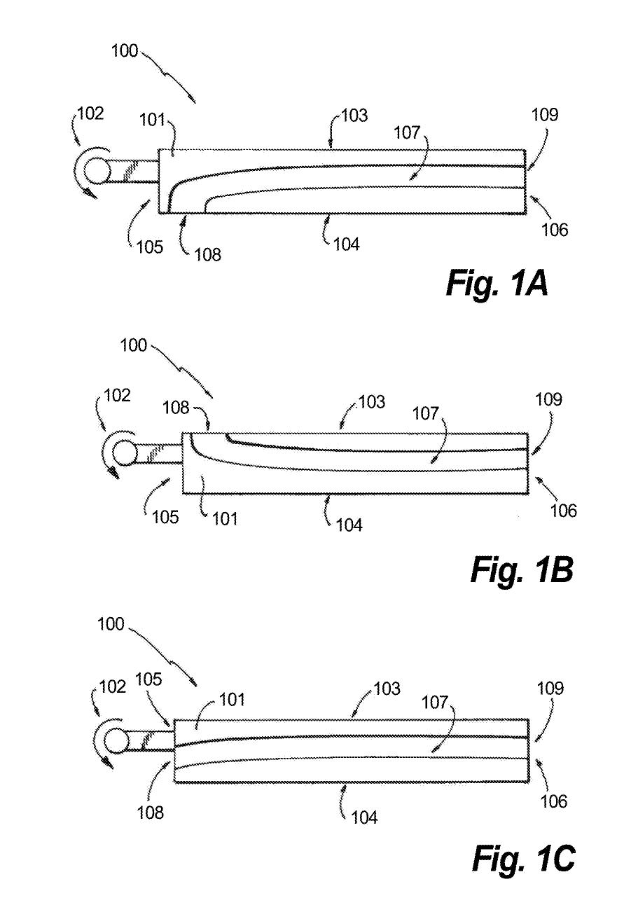

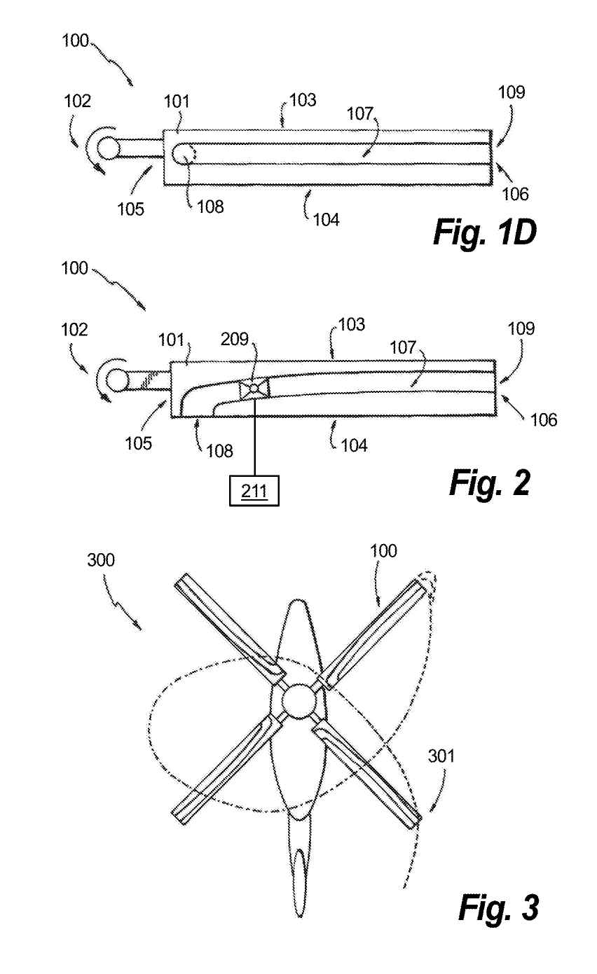

Reference will now be made to the drawings wherein like reference numerals identify similar structural features or aspects of the subject disclosure. For purposes of explanation and illustration, and not limitation, an illustrative view of an embodiment of a rotor blade in accordance with the disclosure is shown in FIG. 1A and is designated generally by reference character 100. Other embodiments and/or aspects of this disclosure are shown in FIGS. 1B-4. The systems and methods described herein can be used to reduce the acoustic effects of rotor blade tip vortices (e.g., noise due to blade vortex interaction).

Referring to FIGS. 1A-1D, a rotor blade 100 includes an elongated body 101 configured to rotate about a hub 102 and having a leading edge 103, a trailing edge 104, a root end 105 and a tip end 106. The rotor blade 100 also includes a centrifugal air flow channel 107 defined in the body 101. The centrifugal air flow channel 107 includes an inlet 108 and outlet 109. The outlet 109 is positioned at or near the tip of the body 101 at near the vortex roll-up formation location such that air flow is injected into the vortex to disrupt the vortex.

As shown in FIG. 1A-1D, the inlet 108 can be positioned and configured on the rotor blade 100 such that flow can freely enter into inlet 108 and travel to outlet 109 due to rotation of rotor blade 100 about hub 102 (e.g., such as a rotorcraft/helicopter blade or propeller). For example, the inlet can be positioned in the trailing edge (e.g., FIG. 1A), in the leading edge (e.g., FIG. 1B), in the root end (e.g., FIG. 1C), in through a partial thickness or entire thickens of the blade (e.g., FIG. 1D), or in any other suitable location or manner. While the drawings show embodiments with a single inlet, more than one inlet 108 is contemplated herein on a single blade 100. While described as using the rotor blade as a centrifugal pump, it is understood that other types of pumps can be used to pump the air in the channel 109, including mechanical pumps and/or vacuums used to create airflow.

Referring to FIG. 2, in certain embodiments, a valve 209 (e.g., a butterfly valve) can he disposed in the centrifugal air flow channel 107 to selectively control flow from the inlet 108 to the outlet 109. The valve can be operatively connected to any suitable controller 211 and/or be configured to mechanically operate in a predetermined manner under predetermined operational regimes (e.g., to open at a certain blade rotational speed, airspeed, blade angle, blade position, or the like). Utilizing a valve 209 can allow desired control of flow through the centrifugal air flow channel 107 to issue flow at a desired rate and/or position to control the effect of BVI selectively. For example, allowing flow through the rotor blade 100 in cruise flight may not be necessary and would lead unnecessary inefficiency such that closing valve 209 may be preferred. In descent, the valve 209 can be opened to allow any suitable amount of flow to control BVI as desired (e.g., when landing at slow speeds over populated areas). The controller 211 can located in the fuselage and/or incorporated into a flight control computer, and be disposed on the rotor hub, or located on a blade 100 and can communicate using wired and/or wireless technologies.

The flow can be controlled to be steady or unsteady as desired. For example, the valve 209 can be controlled to fluctuate between an open condition and a closed condition to produce unsteady flow. Bursts may be created by closing the valve 209 and then opening the valve 209. It is also contemplated that rotor blade 100 can be configured to cause unsteady flow by virtue of its design (e.g., location of the inlet, shape of the rotor blade, other suitable features) which causes pressure fluctuations (e.g., at certain airspeeds).

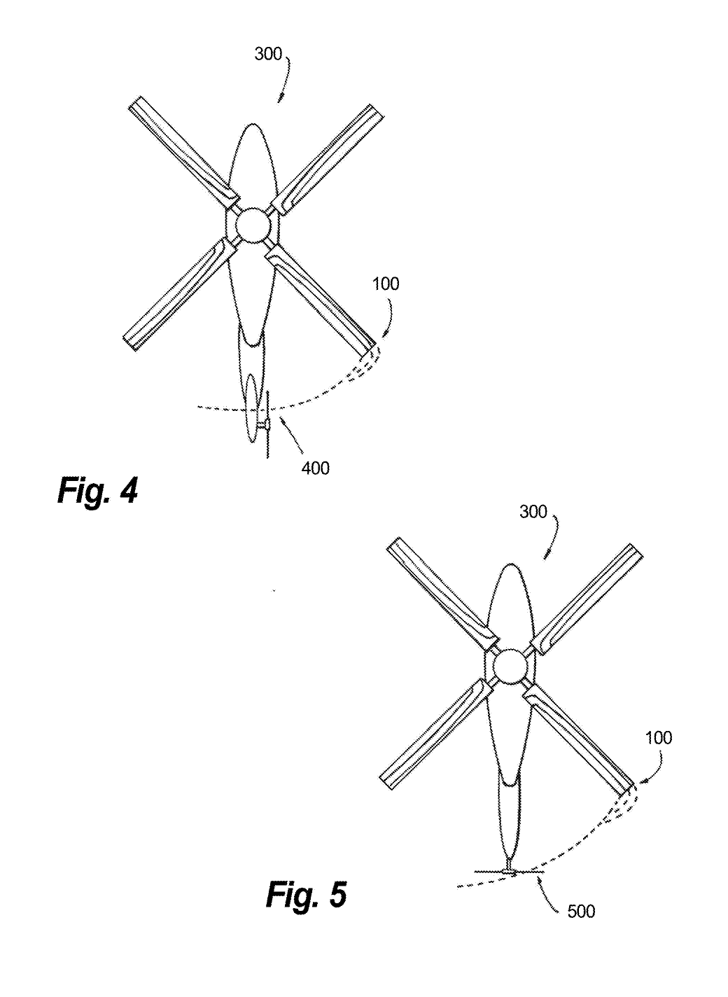

In certain embodiments, it is contemplated that the valve 209 can be controlled as a function of its cyclical location (e.g., to be in one or more open states when the blade is advancing and/or to close when retreating). Referring additionally to FIG. 3, a helicopter 300 is shown issuing flow from the rotor blade 100 only on the advancing side of a helicopter so as to modify the tip vortex at the position 301 where it will most likely to encounter an oncoming blade at a later point in time. However, referring to FIG. 4, a helicopter 300 is shown issuing flow near the tail rotor 400 so as to modify the main rotor tip vortex at the position where it's trajectory will take it through the tail rotor 400. Similarly, referring to FIG. 5, a helicopter 300 is shown issuing flow near the pusher propeller 500 so as to modify the main rotor tip vortex at the position where it will pass through the pusher propeller 500.

The blade vortex can be changed to avoid interacting with another object on the helicopter 300 or to alter the strength of the interaction with another object on the helicopter 300. As described above, the valve 209 can open to change the blade vortex when each of the rotor blades is on an advancing side of the rotational path to prevent interacting with another of the rotor blades on the advancing side of the rotational path. The valve 209 can close when on the retreating side of rotational path.

It is contemplated that the rotorcraft 300 can include a second rotor system (e.g., a counter rotating rotor, a tail rotor, a pusher prop) rotationally disposed on the fuselage. A second valve 209 (e.g., disposed in one or more blades of the second rotor system) can open to change the blade vortex when each of the rotor blades is on an advancing side of the rotational path to prevent interacting with the second rotor system. The second valve can close when on the retreating side of rotational path. A controller 211 can be disposed in the fuselage which controls each of the valves 209 in the rotor blades to selectively open and close the centrifugal air flow channel at the discrete portions of the rotational path of the rotor blade.

The outlet 109 can issue flow perpendicular to the direction of flow around the rotor blade. However, any other suitable angle relative to the flow to affect the vortex as desired is contemplated herein. For example, the outlet 109 can be positioned and/or angled to inject flow into the center of the vortex. While the drawings show embodiments with a single outlet, more than one outlet 109 is contemplated herein on a single blade 100. Also, it is contemplated that the outlet 109 can be positioned on any suitable portion of the tip.

As disclosed herein, the rotor blade 100 can be a helicopter main rotor blade or any other suitable rotating, lift generating body exposed to vortex interaction. For example, the rotor blade 100 can be a tiltrotor proprotor blade, a helicopter tail rotor blade, a pusher/tractor propeller blade, or the like.

In accordance with at least one aspect of this disclosure, a method of controlling a blade vortex issuing from a rotating rotor blade 100 includes injecting a centrifugal air flow into the blade vortex formed on a rotor blade tip 106 to disrupt the blade vortex at a first location in a rotational path of the rotor blade 100 such that the disrupted blade vortex does not interact with another object or interacts at a lower strength. The method also includes interrupting the injection of the centrifugal air flow to no longer disrupt the blade vortex at a second location in a rotational path of the rotor blade 100.

The method can include allowing the centrifugal air flow through a centrifugal air flow channel 107 defined in the rotorcraft blade 100 and through an outlet 109 defined in the blade tip 106 of the blade 100 to disrupt the vortex. The method can include actuating a valve 209 disposed within the centrifugal air flow channel 107 to selectively control the centrifugal air flow through the rotorcraft blade 100 at a specific blade positions.

Embodiments of this disclosure allow for the reduction of blade vortex interaction (BVI) using centrifugally generated air flow (e.g., via rotation of rotorcraft blades) released at the tip of the rotor blade. Blade tip vortex interaction strength is reduced by means of tip air blowing generated by rotational pumping. Reduced vortex interaction strength reduces BVI noise. Also, air can be released at the blade position corresponding to the release point of the rotor tip vortices that interact with the following blades. The air ejected into the flow produces a change in the vortex core strength, rate of diffusion, and/or vortex position relative to the oncoming blade, either from the same rotor or of another nearby rotor system. This effect is dependent on the strength of the tip vortex (flight condition) and ejected mass flow and rate of change.

While shown as a conventional helicopter, it is understood that aspects of the invention can be used in coaxial helicopters, tilt rotor aircraft, fixed wing aircraft, wind turbine blades, and other situations where blades encounter a vortex interaction.

The methods and systems of the present disclosure, as described above and shown in the drawings provide for rotor blades with superior properties including reduced blade vortex interaction noise and vibration. While the apparatus and methods of the subject disclosure have been shown and described with reference to embodiments, those skilled in the art will readily appreciate that changes and/or modifications may be made thereto without departing from the spirit and scope of the subject disclosure.

1. A rotor blade, comprising:
an elongated body having a leading edge, a trailing edge, a root end, and a tip end; a fluid inlet arranged closer to the root end than the fluid outlet;
a fluid outlet arranged at or near the tip end of the elongated body, wherein the outlet is configured to issue flow perpendicular to the direction of flow around the body;
a centrifugal air flow channel defined within the body between the inlet and the outlet to direct air from the inlet to the outlet to issue the flow when the rotor blade is rotating in a rotational path; and
a valve to selectively open and close the centrifugal air flow channel to selectively issue the flow and change a blade vortex issuing from the rotor blade at discrete portions of the rotational path of the rotor blade.

2. The rotor blade of claim 1, wherein the rotor blade is a helicopter main rotor blade.

3. The rotor blade of claim 1, further comprising a controller operatively connected to the valve to control the valve to open and close the centrifugal air flow channel.

4. The rotor blade of claim 1, wherein the inlet is positioned and configured to cause centrifugal flow through the centrifugal air flow channel due to rotation of the blade.

5. The rotor blade of any of claim 1, wherein the inlet is positioned at a root portion of die body.

6. The rotor blade of claim 1, wherein the inlet is defined in the trailing edge of the body.

7. A method of controlling a blade vortex issuing from a rotating rotor blade, the method comprising:
injecting a centrifugal air flow into the blade vortex formed on a rotor blade tip to disrupt the blade vortex at a first location in a rotational path of the rotor blade such that the disrupted blade vortex does not interact with another object; and
interrupting the injection of the centrifugal air flow to no longer disrupt the blade vortex at a second location in a rotational path of the rotor blade.

8. The method of claim 7, further comprising allowing the centrifugal air flow through a centrifugal air flow channel defined in a rotor blade and through an outlet defined in the rotor blade tip of the blade to disrupt the vortex.

9. The method of claim 7, further comprising actuating a valve disposed within the centrifugal air flow channel to selectively control the centrifugal air flow through the rotor blade.

10. The method of claim 7, further comprising wherein injecting air flow into the vortex includes injecting air flow at predetermined rotor blade positions to control how the tip vortex interacts with at least one of a main rotor blade, a tail rotor blade, or a proprotor blade.

11. A rotorcraft, comprising:
a fuselage;
a rotor system rotationally disposed on the fuselage and including rotor blades which rotated about a rotational path to provide lift and/or thrust for the rotorcraft, each rotor blade including:
an elongated body having a leading edge, a trailing edge, a root end, and a tip end;
a fluid inlet arranged closer to the root end than the fluid outlet; a fluid outlet arranged at or near the tip end of the elongated body; a centrifugal air flow channel defined within the body between the inlet and the outlet o direct air from the inlet to the outlet to issue the flow when the rotor blade is rotating in the rotational path; and
a valve to selectively open and close the centrifugal air flow channel to selectively issue the flow and change a blade vortex issuing from the rotor blade at discrete portions of the rotational path of the rotor blade, wherein the blade vortex is changed to avoid interacting with another object on the rotorcraft.

12. The rotorcraft of claim 11, wherein the valve opens to change the blade vortex when each of the rotor blades is on an advancing side of the rotational path to prevent interacting with another of the rotor blades on the advancing side of the rotational path, and closes when on the retreating side of rotational path.

13. The rotorcraft of claim 11, further comprising a second rotor system rotationally disposed on the fuselage, wherein the valve opens to change the blade vortex when each of the rotor blade is on an advancing side of the rotational path to prevent interacting with the second rotor system, and closes when on the retreating side of rotational path.

14. The rotorcraft of claim 11, wherein the inlet is positioned and configured to cause centrifugal flow through the centrifugal air flow channel due to rotation of the blade.

15. The rotorcraft of claim 12, further comprising a controller disposed in the fuselage which controls each of the valves in the rotor blades to selectively open and close the centrifugal air flow channel at the discrete portions of the rotational path of the rotor blade.
